(19) United States
(12) Patent Application Publication
(10) Pub. No.: US 2017/0330442 A1
(43) Pub. Date: Nov. 16, 2017

(54) Emergency reporting device and system thereof

(71) Applicant: Amaryllo International B.V., Zhubei City (TW)

(72) Inventor: Chao-Tung Yang, Zhubei City (TW)

(73) Assignee: Amaryllo International B.V., Zhubei City (TW)

(21) Appl. No.: 15/154,546

(22) Filed: May 13, 2016

(51) Int. Cl. G08B 25/01; G08B 21/04

(52) U.S. Cl. CPC G08B 25/016; G08B 21/0476

(57) ABSTRACT

The present application provides an emergency reporting device and a system thereof. The emergency reporting device includes a receiving module, a communicating module and a controlling module. The receiving module communicates with an external emergency transmitting device so as to receive reporting information. The communicating module communicates with an external communications device which includes an emergency contact list. The controlling module determines whether notification information is transmitted to the communications device from the communicating module according to the reporting information. The controlling module can be passively triggered or can be proactively detecting. The notification information is used to trigger the communications device to contact a contactor in the emergency contact list. As such, an emergency reporting device and a system thereof informs a contactor in another place of conditions of an operator using the emergency transmitting device immediately and allows the contactor to learn the operator's conditions quickly.

### BACKGROUND OF THE INVENTION

### 1. Field of the Invention

The present application is an emergency reporting device and a system thereof, particularly an emergency reporting device and a system thereof for immediately reporting an operator's emergency status to a contactor in another place.

### 2. Description of the Prior Art

Geriatric health care is an issue worthy of attention in a modern society when population ageing is increasingly important. With physical functions degraded, many senior citizens, who encountered incidents such as collision, stumble or unexpected discomfort but were not helped immediately, may suffer from various mishaps.

Likewise, the critically ill patients who need particular health care confront the similar dilemma. It is a painful case that a patient discharged from a hospital cannot contact other people forthwith when he/she had a relapse at home without health care similar to a hospital.

To solve those problems and avoid incidents, some families hire health care workers to take care of senior citizens or patients. In this regard, the health care workers may put senior citizens or patients, who suffered from incidents but were not reported to a hospital within a golden window, in irreversible injury when the workers failed in round-the-clock care of the senior citizens or patients.

Therefore, how to provide an emergency reporting device and a system thereof for immediate reporting emergency status is a technical issue which deserves to be addressed by the persons skilled in the art.

### SUMMARY OF THE INVENTION

To address the problems mentioned previously, the present application describes an emergency reporting device which informs a contactor of an incident immediately.

To achieve the aforementioned objective, the present application provides an emergency reporting device. The emergency reporting device comprises a receiving module, a communicating module and a controlling module. The receiving module is configured to communicate with an external emergency transmitting device and to receive reporting information from the emergency transmitting device. The communicating module is configured to communicate with an external communications device which comprises emergency contact list. The controlling module is connected to both the receiving module and the communicating module. The controlling module determines whether notification information is transmitted to the communications device from the communicating module according to the reporting information. The notification information is used to trigger the communications device to contact a contactor in the emergency contact list.

To achieve the aforementioned objective, the present application provides an emergency reporting system. The emergency reporting system comprises the emergency transmitting device, the communications device and the emergency reporting device. The emergency transmitting device can be triggered by an external operator for generation of reporting information. The communications device comprises an emergency contact list. The emergency reporting device is configured to communicate with the emergency transmitting device; the emergency reporting device, which has acquired the reporting information, triggers the communications device to contact a contactor in the emergency contact list.

Therefore, an emergency reporting device and a system thereof in the present application informs a contactor of an operator's emergency status immediately and allows the contactor to learn the operator's conditions quickly.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIG. 1 is a block diagram for an emergency reporting device in the first embodiment.

FIG. 2 is a block diagram for an emergency reporting device in the second embodiment.

FIG. 3 is a block diagram for an emergency reporting device in the third embodiment.

FIG. 4 is a schematic view of a receiver in an emergency reporting device.

FIG. 5 is a vector diagram of received signal of present application.

FIG. 6 is an operation scenario of the emergency reporting system of present application.

FIG. 7 shows a usage scenario of present application.

FIG. 8 shows another usage scenario of present application.

FIG. 9 shows a reporting schematic diagram of present application.

FIG. 10 shows another reporting schematic diagram of present application.

### DETAILED DESCRIPTION OF THE PREFERRED EMBODIMENT

The following description is about embodiments of the present invention; however it is not intended to limit the scope of the present invention.

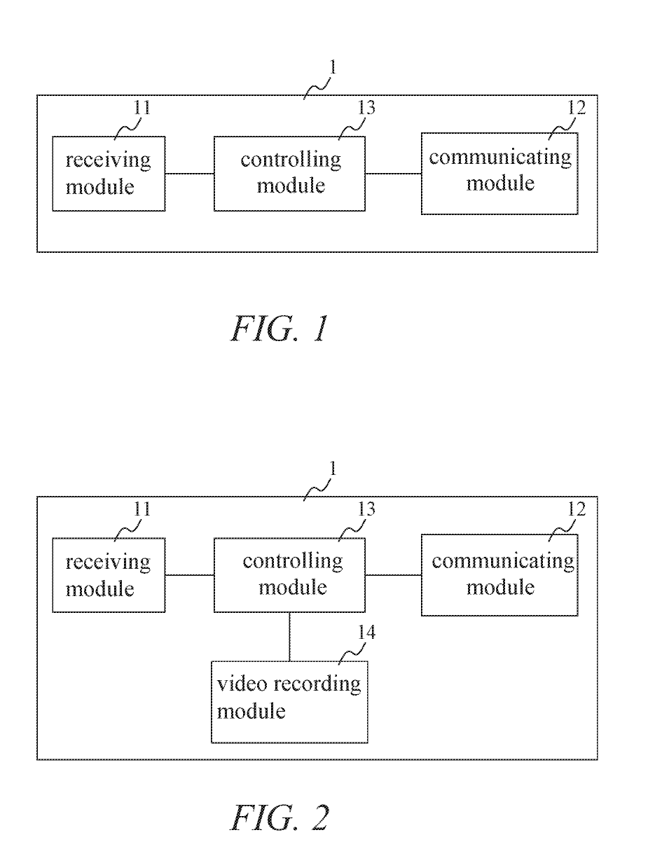

Referring to FIG. 1, which is a block diagram for an emergency reporting device 1 in the first embodiment. The emergency reporting device 1 comprises a receiving module 11, a communicating module 12 and a controlling module 13. The receiving module 11 is configured to communicate with an external emergency transmitting device 2, and receives reporting information from the emergency transmitting device 2. The communicating module 12 is configured to communicate with an external communications device 3 which comprises an emergency contact list. The controlling module 13, which is connected to both the receiving module 11 and the communicating module 12, determines whether notification information is transmitted to the communications device 3 from the communicating module 12 according to the reporting information. The notification information is used to trigger the communications device 3 to contact a contactor in the emergency contact list. The reporting information is trigger information, falling measurement values, or physiological measurement values or a combination thereof.

The receiving module 11 comprises wireless communications circuits (such as radio frequency communications circuits or infrared communications circuits) by which wireless information from the emergency transmitting device 2 is received; similarly, the emergency transmitting device 2 is equipped with wireless communications circuits matching the receiving module 11. The communicating module 12 comprises a wireline communications line such as telephone line or Internet or wireless communications circuits for 2G, 3G, 4G or Wi-Fi network. The controlling module 13 is an electronic circuit device with computing power such as System On chip (SOC), microprocessor or programmable digital circuits. The controlling module 13 further connects or comprises a non-transitory memory device (such as SD card, flash memory, hard drive, etc.) in which the reporting information and the notification information are saved.

Referring to FIG. 2, which is a block diagram for an emergency reporting device 1 in the second embodiment. In contrast to the first embodiment, the second embodiment further comprises a video recording module 14. The video recording module 14 connects the controlling module 13, which depends on the reporting information to acquire catch video data of an operator 20 triggering the emergency transmitting device 2 through the video recording module 14 and transmits the catch video data to the communications device 3 from the communicating module 12 and further to the contactor in the emergency contact list from the communications device 3. The video recording module 14 comprising a camera and a control circuits thereof is able to capture video data of a specific external target. The communications device 3 can be either a mobile communications device or a computer device with wireline/wireless communications circuits. The communications device 3 further connects or comprises a non-transitory memory device in which the emergency contact list is saved.

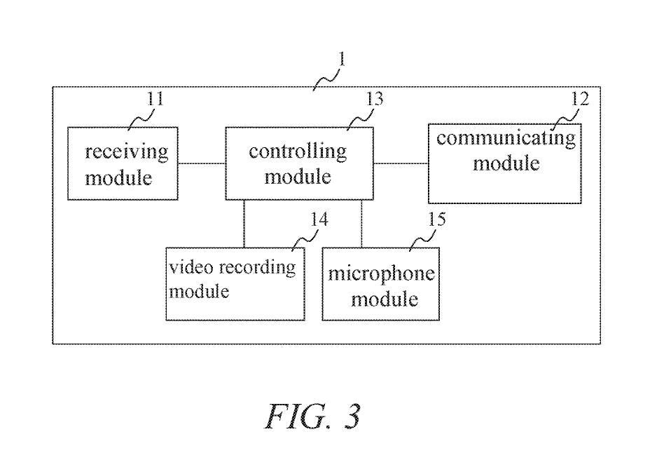

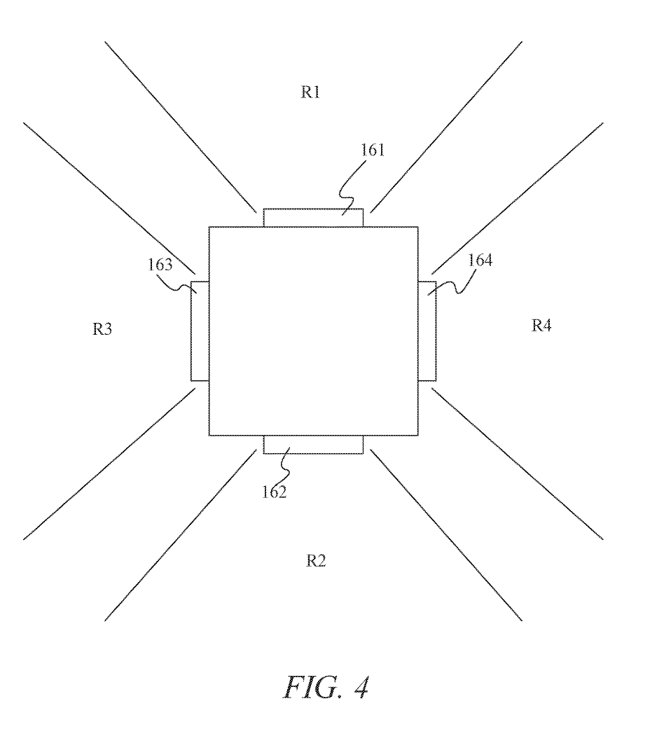

Referring to FIG. 3, which is a block diagram for an emergency reporting device 1 in the third embodiment. In contrast to the first embodiment, the third embodiment further comprises the video recording module 14 and a microphone module 15. In the third embodiment, the controlling module 13 acquires a communicating request from the contactor in the emergency contact list through the communicating module 12 and starts up a communicating mode (such as video communicating mode). The microphone module 15 comprises microphone components and a control circuit thereof.

The controlling module 13, which analyzes a source direction of the reporting information, enables the video recording module 14 to rotate to the source direction and acquire the catch video data. The analysis of a source direction can be completed by following programs.

Program 1 which depends on a plurality of directional receivers (such as directional antennae, directional infrared receivers, etc.) to receive the reporting information and further detects a source direction by a specific directional receiver, as shown in Table 1 and FIG. 4. For example, the controlling module 13 receives a signal from a left receiver 163 for R3 (Receiving Area) and detects a source direction on the left-hand side.

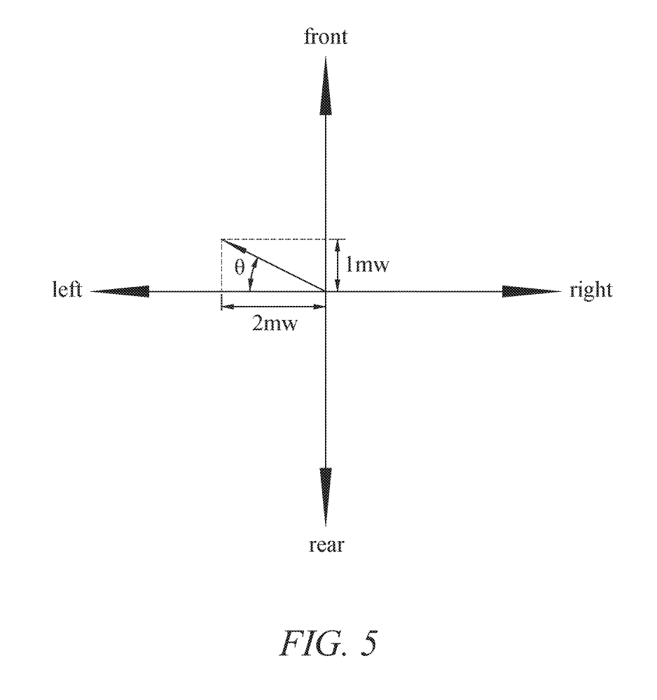

Program 2 which analyzes signals (signal intensity, signal received, etc.) from a plurality of receivers around the emergency reporting device 1 to calculate vectors of signals and further determines a source direction, as shown in Table 2, FIG. 4 and FIG. 5. When the front receiver 161 and the left receiver 163 (directional or omni-directional antennae) receive signals, the controlling module calculates the vector distribution of source directions by Equation (1) and signal intensity over the receivers 161, 163. As shown in an example in Table 2, the source direction is front left and the azimuth equals to 26.5 (clockwise).

$$θ = {tan}^{- 1} ( \frac{1 mW}{2 mW} ) = {tan}^{- 1} ( 0.5 ) = 26.5 ° \qquad Equation ( 1 )$$

The present application further provides the fourth embodiment. In contrast to the first embodiment, the controlling module 13 in the fourth embodiment acquires video data of the operator 20 who operates the emergency transmitting device 2 from the video recording module 14, analyzes behavior patterns (walking features), postures (sitting, standing, lying, etc.) and facial expressions of the operator 20 in video data, finds at least one emergency pattern feature listed in Table 3 or a symptom pattern listed in Table 4, and decides to transmit the notification information. Specifically, the controlling module 13 decides to send the notification information by analyzing features based on weighting value of emergency pattern features (Table 3) or a symptom pattern (Table 4).

TABLE 3

| Emergency Pattern | Video | | weighting |
|---|---|---|---|
| Features in Video Data | Content | | value |
| Walking | Normal | | 0 |
| | Slow | | 1 |
| | Hobble | | 5 |
| Posture | Normal sitting/standing | | 0 |
| | Pressing | Other | 6 |
| | body | Affected | 7 |
| | | part | |

| | | |
|---|---|---|
| | Kneeling | 8 |
| | Lying on the ground | 10 |
| Facial expression | Normal | 0 |
| | Unnatural | 5 |
| | Painful | 10 |

TABLE 4

| Medical History | Video Content |
|---|---|
| Cardiopathy | Holding chest |
| Headache | Pressing head |

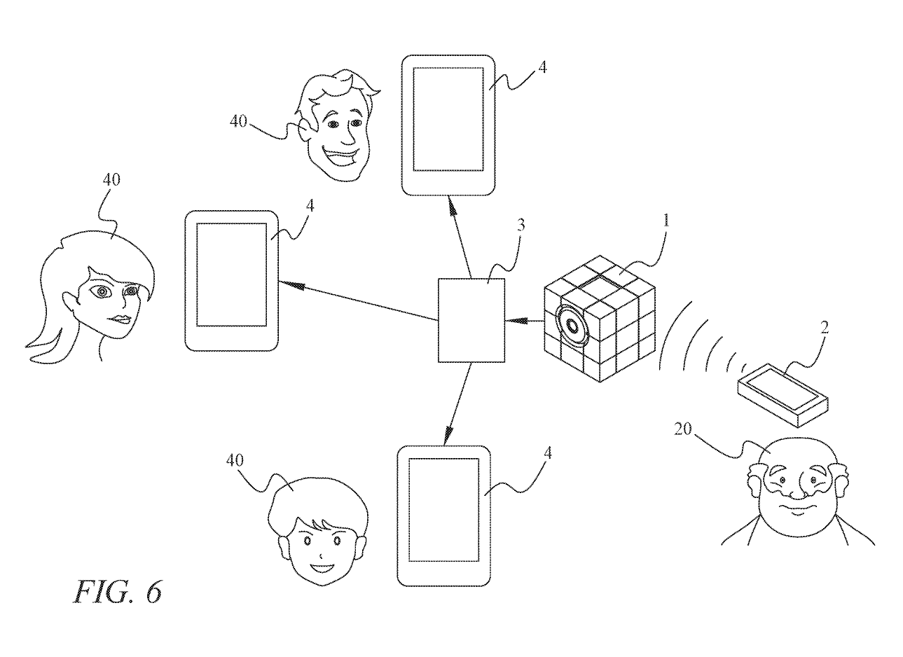

Referring to FIG. 6, which is an operation scenario of then emergency reporting system. The emergency reporting system comprises the emergency transmitting device 2, the communications device 3 and the emergency reporting device 1. The emergency transmitting device 2 which is triggered by an external operator 20 is able to generate reporting information. The communications device 3 comprises an emergency contact list. The emergency reporting device 1, which is configured to communicate with the emergency transmitting device 2, triggers the communications device 3 to contact the contactor (contact device 4) in the emergency contact list after receiving the reporting information. The communications device 3 comprises a login module through which an external user logins the emergency reporting system and edits the emergency contact list.

As shown in FIG. 6, the operator 20 is a senior citizen (or a middle-aged or young person). The emergency transmitting device 2 which was triggered by the senior citizen transmits the reporting information to the emergency reporting device 1; the emergency reporting device 1 communicates with the communications device 3 via a wireline or wireless network and send the communications device 3 the reporting information by which the communications device 3 is triggered to communicate with the contactor (contact device 4) in the emergency contact list. The emergency contact list may record relatives of the senior citizen. As such, the emergency reporting device is effective in noticing family members around the world immediately if the senior citizen had an incident.

The emergency transmitting device 2 can be a push-button remote control device to be pressed and triggered by a senior citizen who has discomfort for generation of the reporting information. The emergency transmitting device 2 can be a wearable device which measures physiological signals (such as heartbeat value, blood glucose level, dermal resistance, etc.). The emergency transmitting device 2 can be a device with some components for falling-incident detection (such as accelerometer, gyroscope, etc.). As the basis of sending the notification information to the communications device 3 from the emergency reporting device 1, the measurement information can be interpreted and transmitted by the emergency transmitting device 2 independently or transmitted to the emergency reporting device 1 directly for data interpretation.

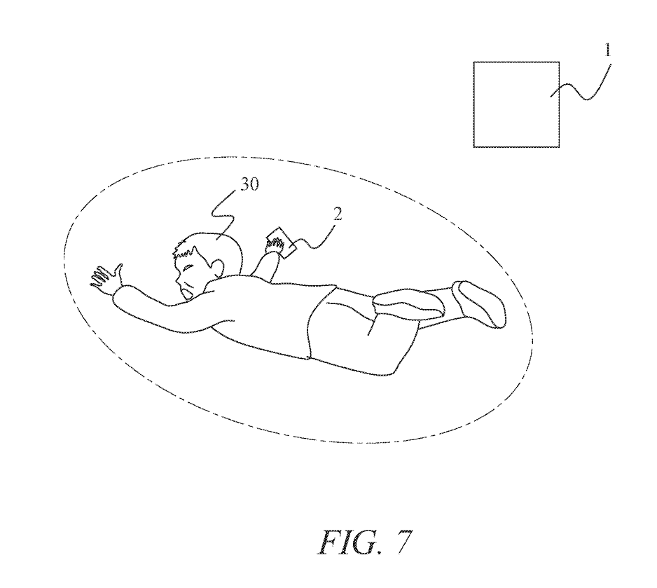

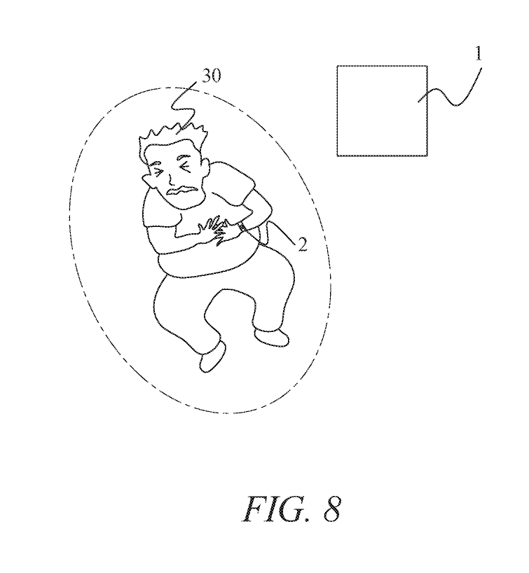

As shown in FIG. 7, the emergency transmitting device 2 is a wearable device with components for falling-incident detection: the emergency transmitting device 2, which has detected the operator 20 stumbled, sends the emergency reporting device 1 the reporting information for triggering follow-up notifications. As shown in FIG. 8, the emergency transmitting device 2 is a wearable device which is able to measure physiological signals: the emergency transmitting device 2, which has detected arrhythmia of the operator 20, sends the emergency reporting device 1 the reporting information for triggering follow-up notifications.

In addition to the emergency transmitting device 2 sending the reporting information, the emergency reporting device 1 tracks the operator 20 dynamically and determine to inform a contactor of any emergent event after analyzing video data related to facial expressions, walking patterns and postures of the operator 20. For example, the emergency reporting device 1, which has recognized behavior of the operator 20 in video data as an emergency pattern feature such as stumble (FIG. 7) or heart trouble (the operator 20 having painful expression or holding the chest in FIG. 8) and completed calculation by weight value (Table 3), informs a specific contactor (contact person 40 or contact device 4) of an emergent event immediately.

For the operator 20 with specific medical history, the operator 20 or the contact person 40 may set up emergency functions of the emergency reporting device 1 in order to recognize specific motions or postures for emergency reporting. For example, the emergency reporting device 1, which is configured to recognize that the operator 20 with medical history of cardiopathy is holding his/her chest, immediately enables a reporting procedure as previously mentioned.

The contact person 40 (a senior citizen's family member) logins the communications device 3 through the login module and edits the emergency contact list (as shown in Table 5) or completes an emergency notification procedure for each notification schedule setting (as shown in Table 6).

TABLE 5

| Contact | Types of contact | Contact information of |
|---|---|---|
| person 40 | devices 4 | contact devices 4 |
| John (son) | Mobile phone | 0958-001-001 |
| | Instant messenger | John_Wu@gmail.com |
| Emma (daughter) | Mobile phone | 0920-002-002 |
| David (grandson) | Instant messenger | David_Wu@gmail.com |
| National Taiwan | Telephone | 02-2312-3456 |
| University Hospital | | |

Each contact person 40 in the emergency contact list may set up one or more contact devices 4 and contact information thereof, for example, the contact person 40 (David) has two contact devices 4, mobile phone (TEL: 0958-001-001) and instant messenger (E-mail account: John_Wu@gmail.com), to which the communications device 3 will transmit the reporting information.

With speed of a communications network as well as information to be processed (as shown in Table 6) considered, the emergency reporting system allows a user to set up a notification procedure for each schedule by which the communications device transmits specific information (texting information or video information) to a contactor.

TABLE 6

| | | | Processing | Notification |
|---|---|---|---|---|
| Information | Category | Type | Time | schedule |
| Default | System | Text | Short | First |
| reporting | default | | | schedule |
| information | | | | |
| Catch video data | Video | Video | Medium | Second |
| | recording | | | schedule |
| Status analysis | Video | Text | Long | Third |
| information | analysis | | | schedule |

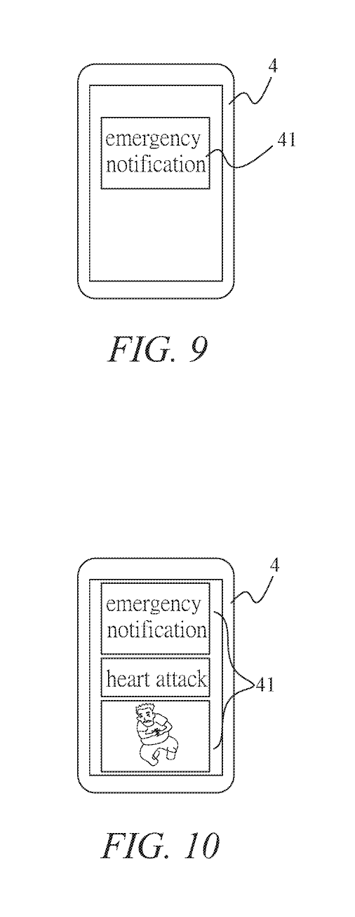

In case of emergency status, the contact device 4 in the first schedule acquires default reporting information (as shown in FIG. 9) by which the contact person 40 learns status immediately. In second and third schedules, the emergency reporting system transmits the catch video data and the status analysis information to the contact device 4 through which the contact person 40 learns the latest messages.

The above application is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An emergency reporting device , comprising:
a receiving module, configured to communicate with an external emergency transmitting device and receive reporting information from the emergency transmitting device;
a communicating module, configured to communicate with an external communications device, wherein the communications device comprises an emergency contact list; and
a controlling module, connected with the receiving module and the communicating module, wherein the controlling module further determines whether transmitting notification information to the communications device through the communicating module according to the reporting information, wherein the notification information is used to trigger the communications device to contact a contactor in the emergency contact list.

2. The device as claimed in claim 1, wherein the notification information is trigger information, falling measurement value, or physiological measurement value.

3. The device as claimed in claim 1, further comprising a video recording module connected with the controlling module, the controlling module further acquiring catch video data of an operator which triggered the emergency transmitting device from the video recording module, and transmitting the catch video data to the communications device by the communicating module and triggering the communications device to contact the contactor in the emergency contact list.

4. The device as claimed in claim 3, wherein the controlling module further analyzes a source direction of the reporting information, and enables the video recording module to rotate to the source direction so as to acquire the catch video data.

5. The device as claimed in claim 4, wherein the receiving module comprises a plurality of directional receiver, the controlling module further determines the source direction according to the directional receiver which received reporting information.

6. The device as claimed in claim 1, wherein the controlling module further acquires a communicating request from the contactor in the emergency contact list and starts up a communicating mode.

7. The device as claimed in claim 6, further comprising a video recording module and a microphone module both connected with the controlling module, wherein the communicating mode is a video communicating mode.

8. The device as claimed in claim 1, further comprising a video recording module connected with the controlling module, the controlling module further acquiring video data of an operator operated the emergency transmitting device, and analyzing a feature of the operator in the video data whether matching an emergency pattern feature so as to determine whether transmitting the notification information.

9. The device as claimed in claim 1, wherein the controlling module further transmits the related notification information according to a notification schedule setting so as to trigger the communications device to transmit designation information to the contactor.

10. The device as claimed in claim 9, wherein the designation information is selected from texting information or video information.

11. The device as claimed in claim 9, wherein the designation information is selected from default reporting information, catch video data, or status analysis information.

12. An emergency reporting system, comprising:
a transmitting device, triggered by an external operator so as to provide reporting information;
a communications device, comprising an emergency contact list;
an emergency reporting device as claimed in any one of claim 1, configured to communicate with the transmitting device, the emergency reporting device further triggering the communications device to contact the contactor in the emergency contact list when acquiring the reporting information.

13. The system as claimed in claim 12, wherein the communications device comprises a login module provided an external user to login and edit the emergency contact list, or set emergency notification procedure.
